(19) United States
(12) Patent Application Publication
(10) Pub. No.: US 2024/0425342 A1
(43) Pub. Date: Dec. 26, 2024

(54) GAS BACKFILLED CONCENTRATE CONTAINER

(71) Applicant: THE COCA-COLA COMPANY, Atlanta, GA (US)

(72) Inventors: William EVANS, Atlanta, GA (US); Brian B. JOHNSON, Atlanta, GA (US); Michael SMITH, Atlanta, GA (US); Xiaoyan HUANG, Atlanta, GA (US); Jin M. LEE, Atlanta, GA (US); Rahul GOKHALE, Atlanta, GA (US); Amy RAYBURN, Atlanta, GA (US); Sharon SACKETT, Atlanta, GA (US)

(21) Appl. No.: 18/732,703

(22) Filed: Jun. 4, 2024

Related U.S. Application Data
(60) Provisional application No. 63/509,295, filed on Jun. 21, 2023.
(60) Provisional application No. 63/603,302, filed on Nov. 28, 2023.

(51) Int. Cl. B67D 1/00

(52) U.S. Cl. CPC B67D 1/0016; B67D 2001/0097

(57) ABSTRACT

The present application provides a beverage dispensing system for dispensing a fluid. The beverage dispensing system may include a nozzle, a container having semi-rigid plastic walls with the fluid therein, a pump for pumping the fluid from the container to the nozzle, and a gas backfill system in communication with the container. The gas backfill system provides a gas to the container as the fluid is pumped from the container to prevent a buildup of a vacuum therein.

### TECHNICAL FIELD

The present application and the resultant patent relate generally to beverage dispensers and more particularly relate to a plastic container for concentrated fluids such as micro-ingredients and the like that is backfilled with a gas to limit an increase in vacuum pressure therein as the concentrated fluids are dispensed.

### BACKGROUND OF THE INVENTION

Generally described, current post-mix beverage dispensers usually mix streams of syrup, concentrate, sweetener, bonus flavors, other types of flavoring, and/or other types of ingredients with water and/or other types of diluent. The ingredients may be stored in bag-in-box containers and the like at a distance from the beverage dispenser. The ingredients may be pumped to the beverage dispenser and mixed with the diluent in or downstream of the nozzle.

Recent improvements in beverage dispensing technology have focused on the use of micro-ingredients. With micro-ingredients, the traditional beverage bases are separated into their constituent parts at much higher dilution or reconstitution ratios. For example, the “COCA-COLA FREESTYLE®” refrigerated beverage dispensing units offered by The Coca-Cola Company of Atlanta, Georgia provide a significant increase in the number and types of beverages that may be offered by a beverage dispenser of a conventional size or footprint. Generally described, the “COCA-COLA FREESTYLE®” refrigerated beverage dispensing units create a beverage by combining a number of highly concentrated micro-ingredients with a macro-ingredient such as a sweetener and a diluent such as still or carbonated water. The micro-ingredients generally are stored in pouches encased within cardboard cartons positioned within or adjacent to the beverage dispenser itself. The number and type of beverages offered by the beverage dispenser thus may be limited only by the number and type of micro-ingredient pouches in communication therewith.

The use of the current pouches with the micro-ingredients therein has the advantage that the pouches collapse as the micro-ingredients are dispensed so as to prevent a vacuum from being formed therein. The current pouches, however, may be made out a number of different layers of largely non-recyclable materials. Moreover, the current pouches may be relatively expensive to produce.

### SUMMARY OF THE INVENTION

The present application and the resultant patent thus provide a beverage dispensing system for dispensing a fluid. The beverage dispensing system may include a nozzle, a container having semi-rigid plastic walls with the fluid therein, a pump for pumping the fluid from the container to the nozzle, and a gas backfill system in communication with the container. The gas backfill system provides a gas to the container as the fluid is pumped from the container to prevent a buildup of a vacuum therein.

The present application and the resultant patent further may provide a method of pumping a fluid from a container with semi-rigid plastic walls. The method may include the steps of placing the container in communication with a vacuum regulator valve and a gas source, pumping the fluid from the container, opening the vacuum regulator valve when a predetermined vacuum develops in the container, and backfilling the container with a gas from the gas source.

The present application and the resultant patent further may provide a concentrate container tray for use with a concentrate container having an offset spout. The concentrate container tray includes an offset catch sleeve at a first end and a retention tongue at a second end. The offset catch sleeve being sized and shaped to accommodate the offset spout.

These and other features and improvements of the present application and the resultant patent will become apparent to one of ordinary skill in the art upon review of the following detailed description when taken in conjunction with the several drawings and the appended claims.

### BRIEF DESCRIPTION OF THE DRAWINGS

FIG. 1 is a schematic diagram of a beverage dispensing system as may be described herein.

FIG. 2 is a perspective view of a concentrate container as may be described herein.

FIG. 3 is a further schematic diagram of the beverage dispensing system with a gas backfill system

FIG. 4 is a partial sectional view of a gas-fluid adapter that may be used with the gas backfill system of FIG. 3

FIG. 5 is a partial sectional view of a vacuum regulator valve that may be used with the gas backfill system of FIG. 3.

FIG. 6 is a chart showing the operation of the vacuum regulator valve of FIG. 5.

FIG. 7 is a perspective view of a micro-ingredient drawer that may be used with the concentrate container of FIG. 2.

FIG. 8 is a perspective view of a micro-ingredient tower that may be used with the concentrate container of FIG. 2.

FIG. 9 is a perspective view of an alternative embodiment of a concentrate container as may be described herein.

FIG. 10 is a side plan view of the concentrate container of FIG. 9.

FIG. 11 is a side plan view of an alternative embodiment of a micro-ingredient tower with a container locking mechanism in an engaged position.

FIG. 12 is a side plan view of the micro-ingredient tower of FIG. 11 with the container locking mechanism in an unengaged position.

FIG. 13 is a perspective view of an alternative embodiment of a micro-ingredient tower with a number of dual concentrate container trays installed therein.

FIG. 14 is a perspective view of the dual concentrate container tray of FIG. 13.

FIG. 15 is a perspective view of a front end of the dual concentrate container tray of FIG. 13.

FIG. 16 is a rear perspective view of the dual concentrate container tray of FIG. 13 with a concentrate container installed therein.

FIG. 17 is a rear perspective view of the dual concentrate container tray of FIG. 13 installed within the micro-ingredient tower.

FIG. 18 is a perspective view of a concentrate container with a backfill valve positioned therein.

FIG. 19 is a perspective view of a micro-ingredient tag reader installed adjacent to the dual concentrate container tray with a concentrate container having a micro-ingredient tag thereon.

### DETAILED DESCRIPTION

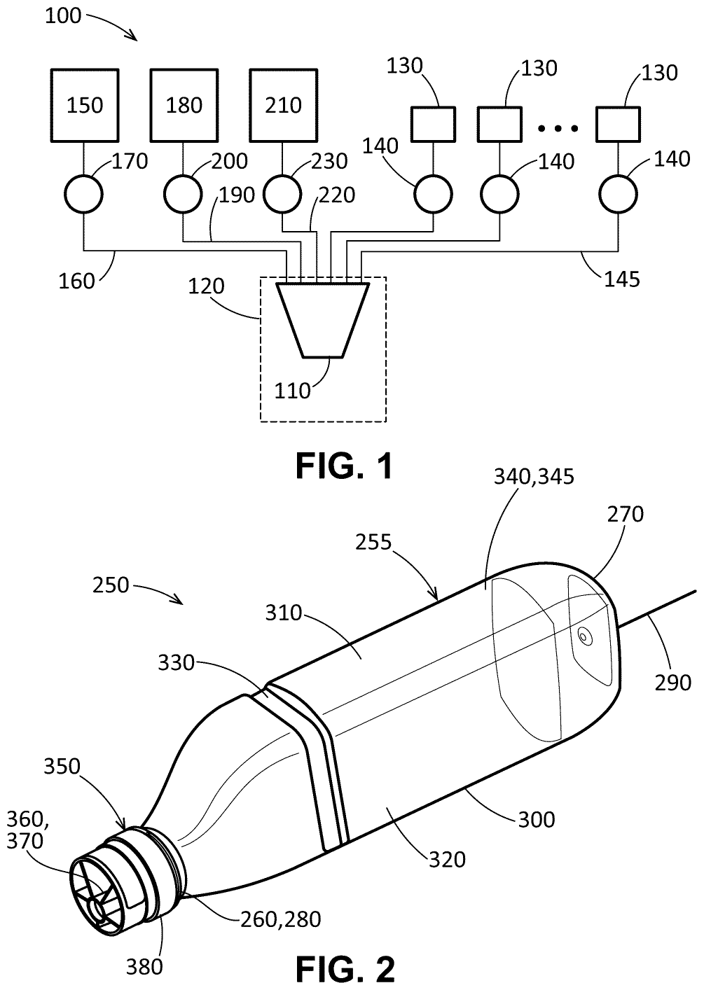

Referring now to the drawings, in which like numerals refer to like elements throughout the several views, FIG. 1 shows an example of a beverage dispensing system 100 as may be described herein. The beverage dispensing system 100 may be used for dispensing many different types of beverages or other types of fluids. Specifically, the beverage dispensing system 100 may be used with diluents, macro-ingredients, micro-ingredients, and other types of fluids. The diluents generally include plain water (still water or non-carbonated water), carbonated water, and other fluids. Any type of fluid may be used herein.

Generally described, the macro-ingredients may have reconstitution ratios in the range from full strength (no dilution) to about six (6) to one (1) (but generally less than about ten (10) to one (1)). The macro-ingredients may include sugar syrup, HFCS (“High Fructose Corn Syrup”), concentrated extracts, purees, and similar types of ingredients. The micro-ingredients may have reconstitution ratios ranging from about ten (10) to one (1) and higher. Specifically, many micro-ingredients may have reconstitution ratios in the range of about 20:1, to 50:1, to 100:1, to 300:1, or higher. The viscosities of the micro-ingredients typically range from about one (1) to about six (6) centipoise or so, but may vary from this range.

The various fluids used herein may be mixed in or about a dispensing nozzle 110. The dispensing nozzle 110 may be a conventional multi-flavor nozzle and the like. The dispensing nozzle 110 may have any suitable size, shape, or configuration. The dispensing nozzle 110 may be positioned within a dispensing tower 120. The dispensing tower 120 made have any suitable size, shape, or configuration. The dispensing tower 120 may extend from a countertop and the like and/or the dispensing tower 120 may be a free-standing structure. The dispensing tower 120 may have a number of the dispensing nozzles 110 thereon.

The micro-ingredients may be stored in a number of micro-ingredient containers 130 or other types of micro-ingredient sources. The micro-ingredient containers 130 may have any suitable size, shape, or configuration. As described above, the micro-ingredient containers 130 traditionally have been flexible plastic pouches positioned within cardboard boxes. Any number of the micro-ingredient containers 130 may be used herein. The micro-ingredient containers 130 may be in communication with the dispensing nozzle 110 via a number of micro-ingredient pumps 140 positioned on a number of micro-ingredient conduits 145. The micro-ingredient pumps 140 may have any suitable volume or capacity. The micro-ingredient containers 130 may be positioned in, adjacent to, and/or remote from the dispensing nozzle 110. For example, the micro-ingredient containers 130 may be positioned under the counter top upon which the dispensing tower 120 rests. Some or all of the micro-ingredient containers 130 may be agitated.

A still water source 150 may be in communication with the dispensing nozzle 110 via a still water conduit 160. Other types of diluents may be used herein. Still water or other types of diluents may be pumped to the dispensing nozzle 110 via a still water pump 170. The still water pump 170 may be may be any type of conventional fluid moving device and made have any suitable volume or capacity. Alternatively, the pressure in a conventional municipal water source may be sufficient without the use of a pump. Any number of still water sources 150 may be used herein.

A carbonated water source 180 may be in communication with the dispensing nozzle 110 via a carbonated water conduit 190. The carbonated water source 180 may be a conventional carbonator and the like. The carbonator may have any suitable size, shape, or configuration. Carbonated water or other types of diluents may be pumped to the dispensing nozzle 110 via a carbonated water pump 200. The carbonated water pump 200 may be any type of conventional fluid moving device and made have any suitable volume or capacity. Any number of carbonated water sources 180 may be used herein. A carbonated water recirculation line also may be used herein.

One or more macro-ingredient sources 210 may be in communication with the dispensing nozzle 110 via one or more macro-ingredient conduits 220. As described above, the macro-ingredient sources 210 may include sweeteners such as high fructose corn syrup, sugar solutions, and the like. The macro-ingredient sources 210 may be a conventional bag-in-box or other type of container in any suitable size, shape, or configuration. Any number of the macro-ingredient sources 210 may be used herein. The macro-ingredients may flow to the dispensing nozzle 110 via a macro-ingredient pump 230. In this case, the macro-ingredient pump 230 may be a controlled gear pump and the like. Other types of pumps may be used herein.

FIG. 2 shows a micro-ingredient container 130 as may be described herein. In this example, the micro-ingredient container 130 may be in the form of a concentrate container 250. The concentrate container 250 may have a thin walled, bottle-like shape 255. The bottle-like shape 255 may extend from an offset spout 260 on a first end to a base 270 on a second end. The offset spout 260 may be of conventional design and may have an offset position 280 with respect to a center axis 290 of the base 270. The base 270 may be largely flat or slightly concave for ease of blow molding. The bottle-like shape 255 of the concentrate container 250 may have a flat bottom wall 300 and a rounded top wall 310 extending from the offset spout 260 to the base 270 with a pair of substantially flat sidewalls 320 extending therebetween. One or more strengthening ribs 330 or similar features may be formed in the rounded top wall 310 and/or the sidewalls 320. The concentrate container 250 may have any convenient size and volume Likewise, although the bottle-like shape 255 is described herein, the concentrate container 250 may have any convenient size, shape, or configuration.

The concentrate container 250 may be made out of a thermoplastic such as Polyethylene Terephthalate (PET) 340 and the like. PET is a type of clear, strong, lightweight, and recyclable thermoplastic. The concentrate container 250 thus may have semi-rigid walls 345, i.e., allowing only a limited amount of sidewall flexing. Other types of thermoplastics and the like also may be used. Other materials including as glass, metals such as aluminum, laminates, and the like also may be used herein.

The concentrate container 250 may be enclosed via a backfill closure 350. The backfill closure 350 may have a fluid port 360 and a gas port 370 formed therein. As will be described in more detail below, the fluid port 360 allows the micro-ingredients or other fluids to flow out while the gas port 370 allows carbon dioxide gas and the like to flow in. Alternatively as will be shown in more detail below, a single port 375 also may be used for both fluids and gas. The backfill closure 350 may be made out of a thermoplastic such as High Density Polyethylene (HDPE) 380. HDPE 380 is a type of strong, lightweight, and recyclable thermoplastic. Other types of thermoplastics and other types of materials may be used herein

In describing the concentrate container 250, the terms “bottom,” “top,” “side,” “end,” “first,” “second,” and the like are used for purposes of relative orientation only and not as absolute positions. For example, any surface of the concentrate container 250 may be used as the bottom or the top as oriented by a user. Further, the terms “length,” “width,” “height,” and the like also refer to relative orientations. Similarly, the term “container” is meant to encompass “bottles,” “cartridges,” “boxes,” “packages,” and any other type of enclosure or packaging. Other components and other configurations may be used herein.

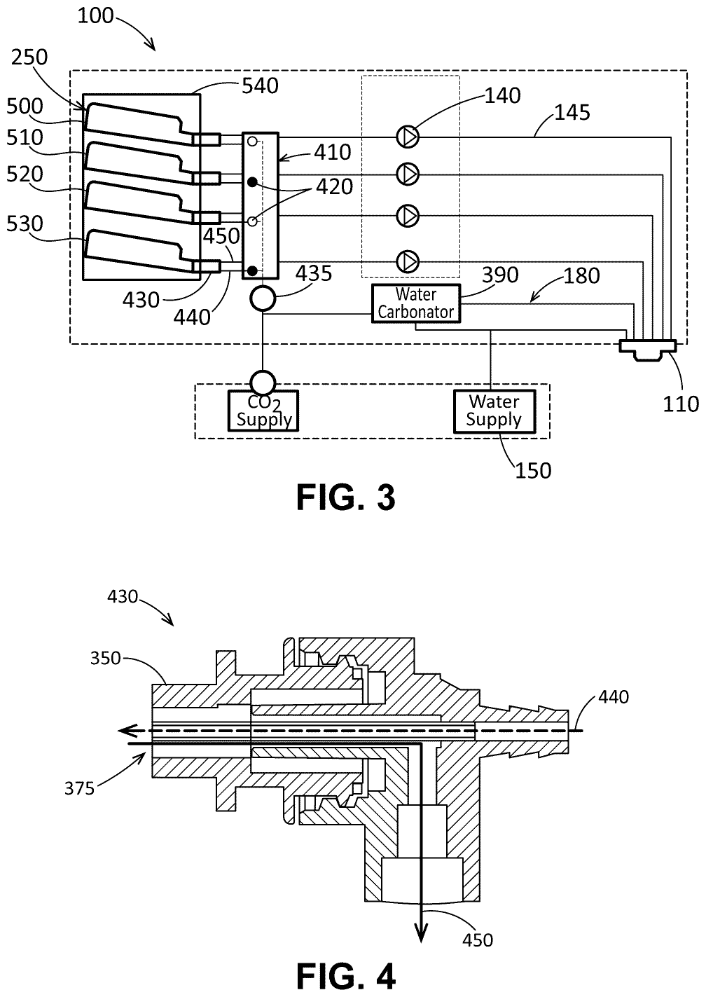

FIG. 3 shows a schematic view of a further example of the beverage dispensing system 100 as may be described herein. The beverage dispensing system 100 includes the still water source 150 and the carbonated water source 180 in communication with the nozzle 110. In this example, the carbonated water source 180 includes a carbonator 390 in communication with the still water source 150 and a carbon dioxide supply 400. The carbonator 390 may be of conventional design and may mix a volume of still water and a volume of carbon dioxide gas to produce carbonated water. Likewise, the carbon dioxide supply 400 may be of conventional design and may provide pressurized carbon dioxide gas at about 120 psi (about 8.3 bar) or so. Any convenient pressure may be used herein. The carbonator 390 and the carbon dioxide supply 400 may be existing equipment within the typical beverage dispensing system 100. Other types of pressurized gasses and pressurized gas sources also may be used herein. (The other components of the beverage dispensing system 100 are not shown herein for clarity.)

The beverage dispensing system 100 also may have a number of the concentrate containers 250 in communication with the nozzle 110 via the micro-ingredient pumps 140 and the micro-ingredient conduits 145. The beverage dispensing system 100 also may have a gas backfill system 410 in communication with the concentrate containers 250. The gas backfill system 410 may include a number of vacuum regulator valves 420 in communication with the carbon dioxide supply 400 and the backfill closures 350 on the concentrate containers 250 via a gas-fluid adapter 430. A pressure regulator valve 435 also may be used to reduce the pressure of the incoming flow of carbon dioxide. The pressure regulator valve 435 may be of conventional design. Other components and other configurations may be used herein.

Generally described, the vacuum regulator valves 420 and the gas-fluid adapters 430 of the gas backfill system 410 may backfill the concentrate containers 250 with a volume of carbon dioxide from the carbon dioxide supply 400 as the micro-ingredient pumps 140 pump the micro-ingredients to the nozzle 110 to prevent the buildup of a vacuum within the concentrate containers 250. The buildup of a vacuum may prevent the micro-ingredient pumps 140 from operating efficiently and/or may damage or weaken the concentrate containers 250.

FIG. 4 shows an example of the gas-fluid adapter 430. The gas-fluid adapter 430 may be positioned between the backfill closure 350 of the concentrate container 250 and the vacuum regulator valve 420 and the micro-ingredient pump 140. Specifically, the gas-fluid adapter 430 may have a gas path 440 in communication with the backfill closure 350 and the vacuum regulator valve 420 for an in-flow of carbon dioxide. Likewise, the gas-fluid adapter 430 may have a fluid path 450 in communication with the backfill closure 350 and the micro-ingredient pump 140 for an out-flow of the micro-ingredients or other fluids. As described above, the backfill closure 350 may use the single port 375 for both fluid and gas. The fluid path 450 may circumferentially surround the gas path 440 and/or the paths 440, 450 may be otherwise positioned or arranged. Other components and other configurations may be used herein.

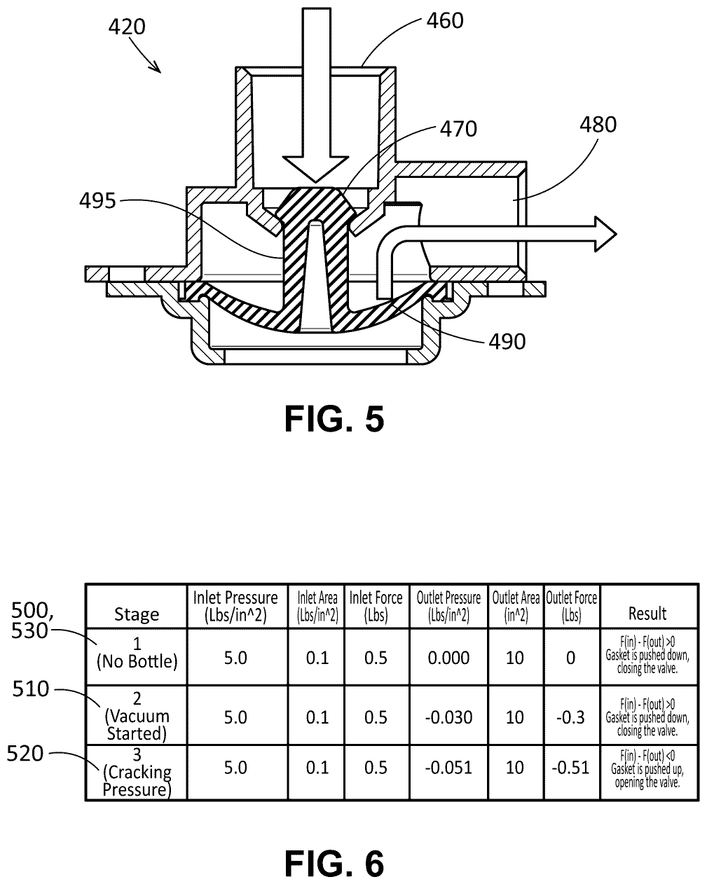

FIG. 5 shows an example of the vacuum regulator valve 420. The vacuum regulator valve 420 may have a gas inlet port 460 with an inlet membrane 470 in communication with the carbon dioxide supply 400. The carbon dioxide supply 400 may provide carbon dioxide at a relatively constant 5.0 psi (about 0.34 bar) or so (via the pressure regulator valve 435). Other pressures may be used herein Likewise, the vacuum regulator valve 420 may have a gas outlet port 480 with an outlet membrane 490. The area of the outlet membrane 490 may be larger than that of the inlet membrane 470 such that a small increase in the pressure on the outlet membrane 490 cause by an increase in the vacuum within the concentrate container 250 so as to open the vacuum regulator valve 420 and allow a flow of carbon dioxide therein. As is shown, the inlet membrane 470 and the outlet membrane 490 are opposite sides of an internal vacuum plunger 495. Other components and other configurations may be used herein.

Specifically, the vacuum regulator valve 420 functions by balancing the pressures against the surface areas of the membranes 470, 490 of the vacuum plunger 495:

$$\sum F = {P}_{in} \times {A}_{in} - {P}_{out} \times {A}_{out}$$

$${F}_{in} = {P}_{in} \times {A}_{in}$$

$${F}_{out} = {P}_{out} \times {A}_{out}$$

Where Ain, Aout, and Pin are all constant such that the inlet forces remain constant. Likewise, Aout may be greater than Ain, such that a small increase in Pout has a multiplicative impact on the outlet forces, causing the vacuum regulator valve 420 to open with a small vacuum at the outlet membrane 490.

FIG. 6 shows the operation of the vacuum regulator valve 420 with the four concentrate containers 250 of FIG. 3. A first concentrate container 500 is new. The vacuum regulator valve 420 is closed because the inlet pressure is steady from the carbon dioxide supply 400 at about 5.0 psi (about 0.34 bar) or so while the outlet pressure is zero. In a second concentrate container 510, a vacuum begins to build as the micro-ingredients are dispensed therefrom. The vacuum regulator valve 420 remains closed because the inlet pressure remains steady at about 5.0 psi (about 0.34 bar) or so while the outlet pressure has only increased to about −0.03 psi (about −0.02 bar) or so. In a third concentrate container 520, the vacuum continues to build as the micro-ingredients are dispensed therefrom. The vacuum regulator valve 420 now opens as the outlet pressure reaches about −0.051 psi (about −0.00351 bar) or so, i.e., the outlet pressure is greater than then inlet pressure. Once the vacuum regulator valve 420 is open, carbon dioxide flows from the carbon dioxide supply 400 into the concentrate container 520 until the pressure therein again drops. A fourth concentrate container 530 is new, thus again starting the cycle.

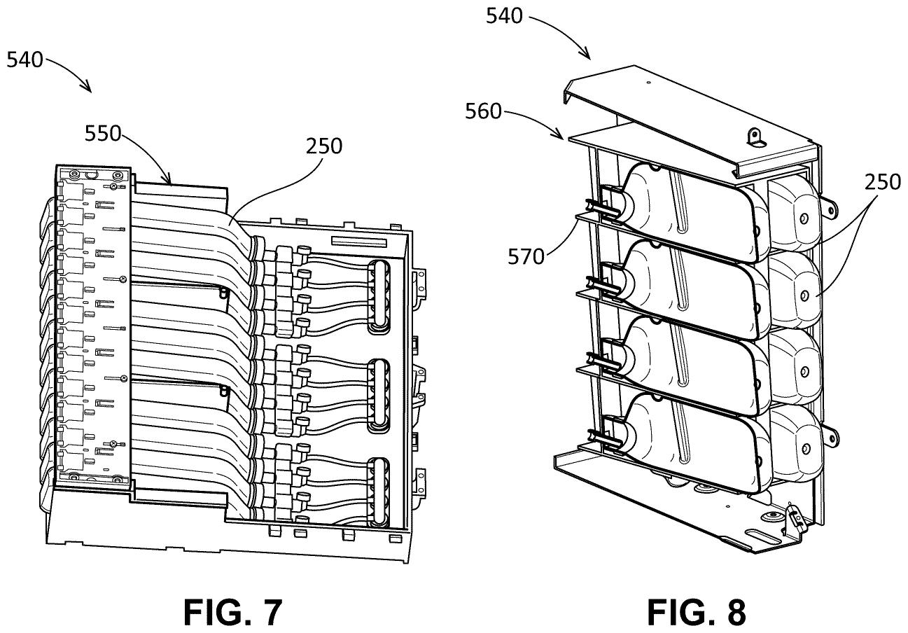

FIGS. 7 and 8 show different examples of concentrate container storage devices 540. Specifically, FIG. 7 shows an example of a micro-ingredient drawer 550. A number of the concentrate containers 250 may be positioned horizontally and connected to the gas-fluid adapters 430, the vacuum regulator valves 420, and the micro-ingredient pumps 140. FIG. 8 shows an example of a micro-ingredient tower 560. A number of the concentrate containers 250 may be positioned vertically on a number of shelves 570. As will be described in more detail below, the shelves 570 of the micro-ingredient tower 560 may be capable of reciprocating movement so as to agitate the micro-ingredients therein. The nature of the concentrate container storage device 540 may depend on the overall configuration of the specific beverage dispensing system 100. Other types of concentrate container storage device 540 may be used herein. Other components and other configurations may be used herein.

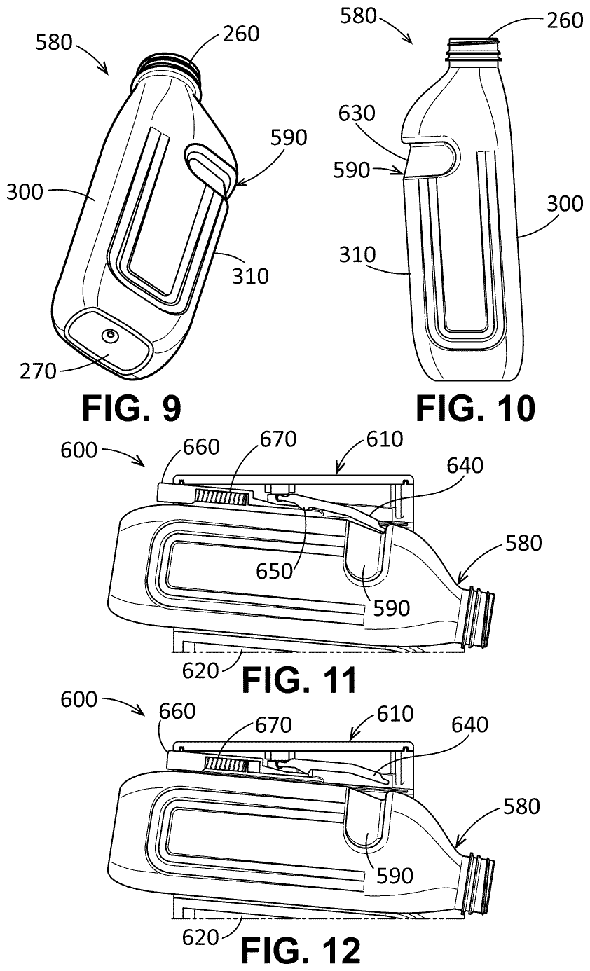

FIGS. 9 and 10 show a further example of a concentrate container 580. In this example, the concentrate container includes a locking detent 590 formed therein. FIGS. 11 and 12 show a further example of a micro-ingredient tower 600. In this example the micro-ingredient tower 600 includes a container locking mechanism 610 positioned about the shelves 620 therein. The concentrate container 580 may be largely similar to the concentrate container 250 described above with the addition of the locking detent 590. Specifically, the locking detent 590 may be positioned about the rounded top wall 310 instead of or in addition to the ribs 330. The locking detent 590 may have an inwardly inclined base wall 630 with an inward angle within the rounded top wall 310 in the direction of the offset spout 260. The nature of the inward angle may vary. The locking detent 590 may have any convenient overall size, shape, or configuration.

The container locking mechanism 610 may include a swing arm 640 with a pivot 650 on one end and a piston 660 with an internal spring 670 on the other end. When the concentrate container 580 is slid onto the shelf 620 of the micro-ingredient tower 600, the swing arm 640 may travel along the top of the concentrate container 580 until the swing arm 640 falls into the inclined base wall 630 of the locking detent 590 and is engaged therein. The concentrate container 580 is thus locked into place within the shelf 620. To remove the concentrate container 580, the piston 660 of the container locking mechanism 610 may engage the pivot 650 of the swing arm 640 so as to lift the swing arm 640 out of the locking detent 590. The concentrate container 580 is now free to be removed from the shelf 620. The container locking mechanism 610 may use other types of conventional drive means in addition to the spring 670 to maneuver the swing arm 640 as desired. Other components and other configurations may be used herein.

As described above, some of the micro-ingredients may be emulsions that require physical agitation to remain homogeneous. Agitation may be provided by moving the concentrate container 580 on the shelf 620 in the micro-ingredient tower 600 or elsewhere in a substantially cyclic or other type of motion. Such motion may require that the concentrate container 580 has an enlarged capacity to allow for the agitation of the micro-ingredients within the rigid structure. The concentrate container 580 thus may have an extra ten percent capacity or so. Differing capacities may be used herein depending upon the nature of the micro-ingredients and other parameters. Internal features also may be added to the concentrate container 580 to promote turbulence in the movement of the micro-ingredients therein.

Similarly, the carbon dioxide of the gas backfill system 410 also may be used to agitate the micro-ingredients within the concentrate container 580. Specifically, increasing the pressure inside the concentrate container 580 allows more carbon dioxide to enter therein. Bubble formation created near the injection port 375 or elsewhere may rise through the micro-ingredients so as to cause agitation within the concentrate container 580. The bubble formation may adequately mix the micro-ingredients therein, although this method may require that the concentrate container 580 is positioned in a substantially vertical configuration. The container locking mechanism 610 maintains the concentrate container 580 in position during any of the agitation techniques.

The use of the concentrate containers 250, 580 described herein thus may provide a considerable cost savings given the use of the PET material 340. The PET material 340 is both less expensive than the known pouches described above and also has the considerable advantage of being recyclable. Specifically, instead of the known multi-layer pouches, the concentrate container 250, 580 has the single thin, semi-rigid PET wall structure and thus may be easily recycled.

Likewise, the use of the gas backfill system 410 addresses the issue of a vacuum building within the concentrate container 250, 580 through the backfill with carbon dioxide from the carbon dioxide supply 400. The carbon dioxide supply 400 may be existing equipment in the beverage dispensing system 100 and thus adds no additional costs. The backfill with carbon dioxide thus avoids a vacuum within the concentrate containers 250, 580 so as to allow the micro-ingredient pumps 140 to operate as intended without damaging or weakening the concentrate container 250, 580.

Although the concentrate containers 250, 580 have been discussed in the context of micro-ingredients, it is understood that the concentrate containers 250, 580 and the gas backfill system 410 may be used to dispense any type of fluid from any type of semi-rigid container. The gas backfill system 410 and the like functions to prevent the buildup of an internal vacuum to allow efficient dispensing.

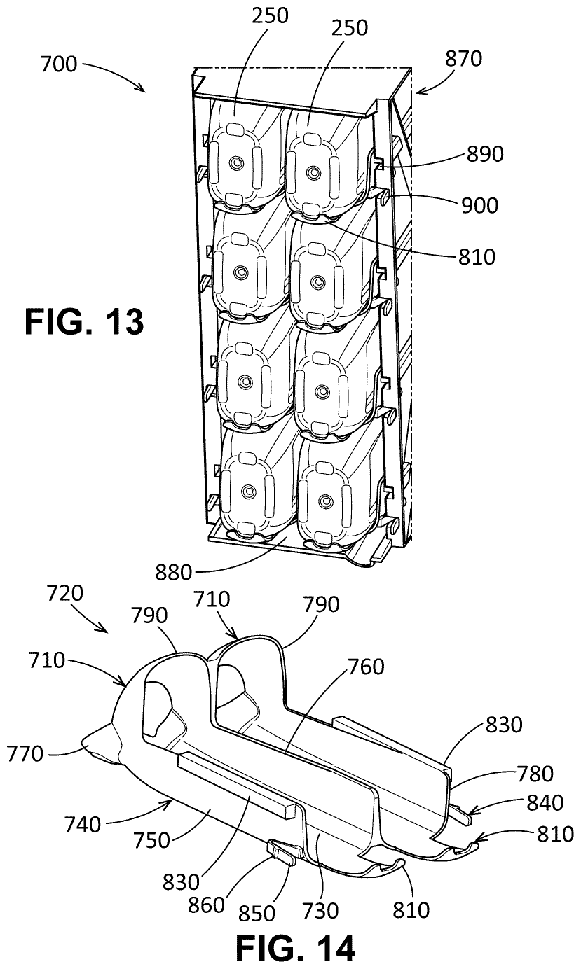

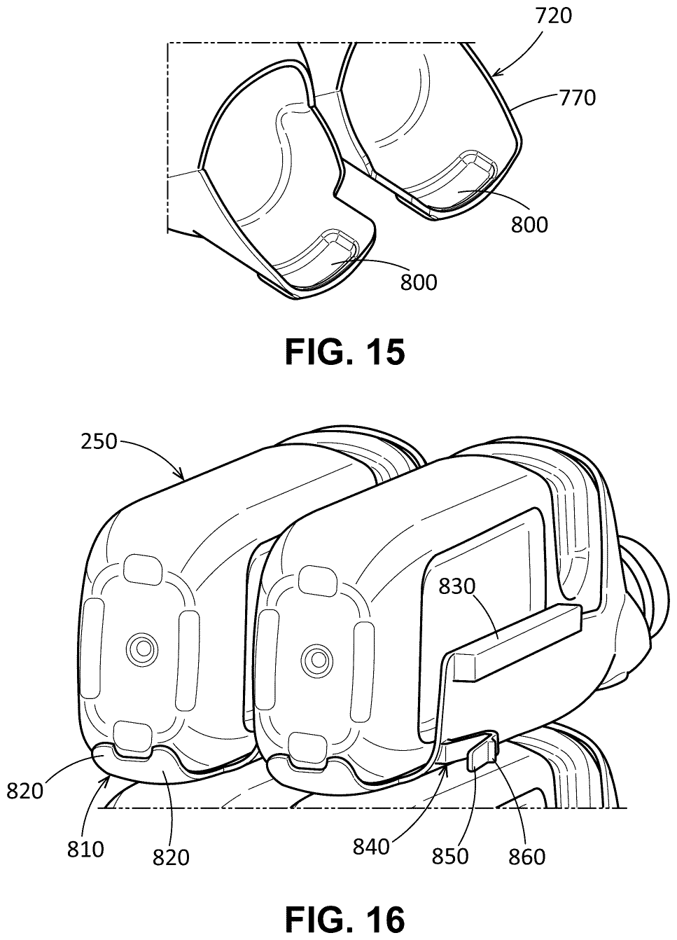

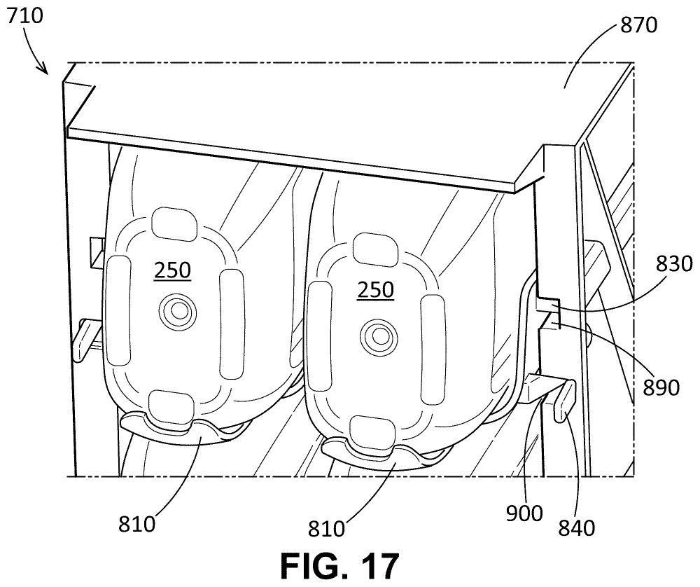

FIGS. 13-17 show a further embodiment of a micro-ingredient tower 700. In this example, the micro-ingredient tower 700 includes a number of concentrate container trays 710. Specifically, a number of dual concentrate container trays 720 formed with two concentrate container trays 710. Each concentrate container tray 710 is shaped and sized for a concentrate container 250 to be securely positioned therein. Although four dual concentrate container trays 720 are shown in the micro-ingredient tower 700, any number of the dual concentrate trays 720 may be used in any position.

Each of the concentrate container trays 710 of the dual concentrate container trays 720 has a substantially flat floor 730 and a pair of partially curved sidewalls 740. The substantially flat floor 730 accommodates the flat bottom wall 300 of the concentrate container 250 while the partially curved sidewalls 740 accommodate the sidewalls 320 of the concentrate container 250. The sidewalls 740 of each concentrate container tray 710 of the dual concentrate container tray 720 define a pair of outer sidewalls 750 and a shared inner sidewall 760.

Each concentrate container tray 710 extends from a front end or a first end 770 to a rear end or a second end 780. The first end 770 may have an offset catch sleeve 790 that extends between each pair of an outer sidewall 750 and a shared inner sidewall 760. The offset catch sleeve 790 may be shaped and sized to accommodate the offset spout 260 and the rounded top wall 310 of the concentrate container 250. The substantially flat floor 730 about the first end 770 may have a drip tray 800 formed therein adjacent to the offset catch sleeve 790. The drip tray 800 may be positioned adjacent to the offset spout 260 of the concentrate container 250. The substantially flat floor 730 about the second end may have a retention tongue 810 formed therein. The retention tongue 810 may have two upwardly curved members 820. The retention tongue 810 may be sized and shaped for the base 270 of the concentrate container 250 to be positioned and secured therein. Other components and other configurations may be used herein.

Each of the outer sidewalls 740 may include a support rail 830 thereon. The support rails 830 may have an elongated rectangular or rod like shape along the length of the outer sidewalls 740 in whole or in part. Each of the outer sidewalls 740 may include a snap wing 840 position towards the second end 780. Each snap wing 840 may have a flexible “V” like shape 850 with an outer catch 860. Other components and other configurations may be used herein.

As described above, the micro-ingredient tower 700 accommodates a number of the dual concentrate container trays 710 therein. The micro-ingredient tower 700 may have an outer frame 870 that defines a number of dual micro-ingredient container tray bays 880. For each bay 880, the outer frame 870 may have a pair of support slots 890 and a pair of locking apertures 900. The support slots 890 may be sized to accommodate and support the support rails 830 of the dual concentrate container trays 710 therein. Likewise, the locking apertures 900 may be sized to accommodate the snap wings 840 therein. Specifically, the flexible V-like shape 850 of the snap wings 840 may pass through the locking apertures 900 and snap back such that the outer catch 860 locks into place within the locking apertures 900. Other component and other configurations may be used herein.

In use, a concentrate container 250 may be positioned within each concentrate container tray 710 of the dual concentrate container tray 720. Specifically, the offset spout 260 of each concentrate container 250 may be inserted within the offset catch sleeve 790 of each concentrate container tray 710. Once inserted, the base 270 of the concentrate container 250 may be pushed into the curved members 820 of the retention tongue 810. The base 270 may be received into the retention tongue 810 with an audible “snap” to confirm that the concentrate container 250 is securely retained within the concentrate container tray 710. The dual concentrate container tray 720 may be inserted within a selected bay 880 of the micro-ingredient tower 700. The dual concentrate container tray 720 may be maneuvered along the support rails 830 and the support slots 890 until the snap wings 840 click into place within the locking apertures 900 of the outer frame 870 of the micro-ingredient tower 700. The dual concentrate container tray 720 likewise may be removed by depressing the snap wings 840 and removing the dual concentrate container tray 720 from the bay 880.

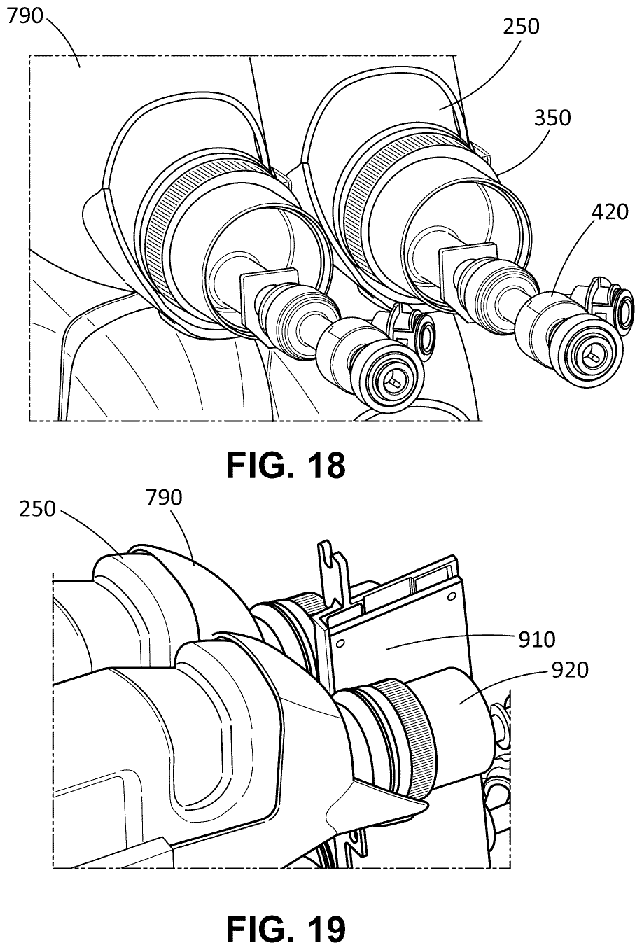

As is shown in FIG. 18, the vacuum regulator valve 420 may be inserted into the backfill closure 350 of the concentrate container 250 so as to supply concentrate to the beverage dispensing system 100 as described above. The drip tray 800 is positioned to catch any drop of liquid during the insertion and removal process. Likewise as is shown in FIG. 19, a micro-ingredient tag reader 910 may read a micro-ingredient tag 920 on the concentrate container 250 to insure that the correct concentrate container 250 is in the correct bay 880. The micro-ingredient tag reader 910 and the micro-ingredient tag 920 may be of conventional design. Other components and other configurations may be used herein.

The present application thus provides a new, removable concentrate container tray 710 that allows the beverage dispensing system 100 to align, capture, and dispense micro-ingredients. Specifically, the concentrate container tray 710 provides alignment for a new concentrate container 250 with the backfill closure 350 and prevents leaking during installation and removal. The concentrate container tray 710 also orients the micro-ingredient tags 920 with the micro-ingredient tag reader 910 for proper reading. The concentrate container tray 710 needed to be easy to remove to allow access to other components in the beverage dispensing system 100 and easy to clean with no additional tools required for removal. The concentrate container tray 710 also needed to ensure that the concentrate containers 250 were properly captured so that they would not loosen during operation or agitation of the micro-ingredient tower 700 as this could cause a disruption to the ability of the overall beverage dispensing system 100 to dispense beverages.

To ensure alignment with the backfill closure 350, the concentrate container tray 710 was designed with an offset geometry forming a negative of the front portion of the concentrate container 250. During installation, the offset catch sleeve 790 captures the offset spout 260 of the concentrate container 250 and guides the offset spout 260 into the backfill closure 350 and the vacuum regulator 420. Rotation of the container 250 is limited to an acceptable range of clearance between the concentrate container 250 and the tray sidewalls 740. The alignment of the concentrate container 250 is also required to read properly the micro-ingredient tags 920. Capturing the front end of the concentrate container 250 guarantees that the micro-ingredient tag 920 remains consistently readable by the micro-ingredient tag reader 910 during each installation.

The use of the retention tongue 810 mitigates leaks by capturing the back end of the concentrate container 250. The retention tongue 810 offers both a visual queue to the user that the backfill closure 350 is fully seated and a physical catch to prevent the concentrate container 250 from backing out of the concentrate container tray 710. Additionally, the concentrate container tray 710 incorporates the drip tray 800 for cleanliness. The backfill closures 350 may contain a very small amount of residual fluid that leaks out during insertion and removal. The drip tray 800 thus incorporates a small reservoir for these drops to fall into, preventing drips from landing on other concentrate containers 250 or the tower floor.

It should be apparent that the foregoing relates only to certain embodiments of the present application and the resultant patent. Numerous changes and modifications may be made herein by one of ordinary skill in the art without departing from the general spirit and scope of the invention as defined by the following claims and the equivalents thereof.

We claim:

1. A beverage dispensing system for dispensing a fluid, comprising:
a nozzle;
a container with the fluid therein;
the container comprising semi-rigid plastic walls;
a pump for pumping the fluid from the container to the nozzle; and
a gas backfill system in communication with the container;
wherein the gas backfill system provides a gas to the container as the fluid is pumped from the container to prevent a buildup of a vacuum therein.

2. The beverage dispensing system of claim 1, wherein the gas backfill system comprises a vacuum regulator valve in communication with a carbon dioxide supply with the gas therein.

3. The beverage dispensing system of claim 2, wherein the vacuum regulator valve comprises an inlet membrane in communication with the carbon dioxide supply and an outlet membrane in communication with the container.

4. The beverage dispensing system of claim 3, wherein the vacuum regulator valve opens when an outlet force on the outlet membrane exceeds an inlet force on the inlet membrane.

5. The beverage dispensing system of claim 2, wherein the gas backfill system comprises a gas-fluid adapter in communication with the container, the vacuum regulator valve, and the pump.

6. The beverage dispensing system of claim 5, wherein the gas-fluid adapter is in communication with the container and the vacuum regulator valve via a gas path.

7. The beverage dispensing system of claim 5, wherein the gas-fluid adapter is in communication with the container and the pump via a fluid path.

8. The beverage dispensing system of claim 5, wherein the container comprises a backfill closure thereon.

9. The beverage dispensing system of claim 8, wherein the backfill closure comprises one or more ports thereon.

10. The beverage dispensing system of claim 1, wherein the container comprises an offset spout.

11. The beverage dispensing system of claim 10, wherein the container comprises a flat bottom wall and a rounded top wall.

12. The beverage dispensing system of claim 1, wherein the semi-rigid plastic walls comprise a Polyethylene Terephthalate material.

13. The beverage dispensing system of claim 1, wherein the container comprises a locking detent.

14. The beverage dispensing system of claim 13, further comprising a micro-ingredient tower with a container locking mechanism to lock the container into place via the locking detent.

15. A method of pumping a fluid from a container with semi-rigid plastic walls, comprising:
placing the container in communication with a vacuum regulator valve and a gas source;
pumping the fluid from the container;
opening the vacuum regulator valve when a predetermined vacuum develops in the container; and
backfilling the container with a gas from the gas source.

16. A concentrate container tray for use with a concentrate container having an offset spout, comprising:
an offset catch sleeve at a first end;
the offset catch sleeve being sized and shaped to accommodate the offset spout; and
a retention tongue at a second end.

17. The concentrate container tray of claim 16, further comprising a floor extending between the first end and the second end.

18. The concentrate container tray of claim 17, wherein the floor comprises a drip tray formed at the first end.

19. The concentrate container tray of claim 16, further comprising a dual concentrate container tray.

20. The concentrate container tray of claim 19, wherein the dual concentrate container tray comprises a pair of outer sidewall and a shared inner sidewall.
